(19) United States
(12) Patent Application Publication
(10) Pub. No.: US 2025/0138047 A1
(43) Pub. Date: May 1, 2025

(54) SCANNING PROBE MICROSCOPE AND SAMPLE USED THEREIN

(71) Applicant: Hitachi High-Tech Corporation, Minato-ku, Tokyo (JP)

(72) Inventors: Kaifeng ZHANG, Tokyo (JP); Masahiro WATANABE, Tokyo (JP); Takenori HIROSE, Tokyo (JP)

(73) Assignee: Hitachi High-Tech Corporation, Minato-ku, Tokyo (JP)

(21) Appl. No.: 18/684,171

(22) PCT Filed: Jul. 4, 2022
(86) PCT No.: PCT/JP2022/026580

§ 371 Date: Feb. 15, 2024

(30) Foreign Application Priority Data
Aug. 20, 2021 (JP) 2021-134656

(51) Int. Cl. G01Q 20/02; G01N 21/65; G01Q 30/02; G01Q 60/22

(52) U.S. Cl. CPC G01Q 20/02; G01N 21/658; G01Q 30/02; G01Q 60/22

(57) ABSTRACT

A scanning probe microscope in which an objective lens used to radiate exciting light and collect Raman scattering light can be disposed more near a sample and a tip is provided. The scanning probe microscope includes: a sample holder configured to hold a sample; a tip disposed near the sample; an exciting light source configured to output exciting light; an objective lens configured to condense the exciting light and radiating the exciting light to the tip; a light reception unit configured to detect scattering light generated from the sample through the radiation of the exciting light; and an incident position adjustment unit configured to cause the exciting light to be incident on a position deviating from an optical axis of the objective lens.

### TECHNICAL FIELD

The present invention relates to a scanning probe microscope including a tip disposed to be close to a sample.

### BACKGROUND ART

Scanning near-field optical microscopes (SNOMs) are devices capable of measuring optical properties or physical property information of surfaces of samples with high resolutions. As one of scanning probe microscopes in which SNOMs are applied, there is a tip-enhanced Raman scattering (TERS) microscope radiating exciting light to a tip disposed to be close to a sample and enhancing Raman scattering light generated from the sample.

PTL 1 discloses a TERS microscope in which disposition of a tip and an objective lens condensing exciting light and Raman scattering light is corrected to reduce a ratio of absorption or reflection of the Raman scattering light by a part of the tip. Specifically, the objective lens and the tip are disposed so that an angle formed between an optical axis of the objective lens and a central axis of the tip is greater than an angle formed between the optical axis of the objective lens and a perpendicular line of an upper surface of the sample in a plane on a side of the upper surface of the sample, the plane being perpendicular to the upper surface.

### CITATION LIST

### Patent Literature

PTL 1: JP6669759B

### SUMMARY OF INVENTION

### Technical Problem

However, in PTL 1, it is not taken into consideration that the objective lens used to radiate exciting light is disposed near the sample and the tip. That is, in PTL 1, since the exciting light is incident along the optical axis of the objective lens tilted with respect to the perpendicular line of the upper surface of the sample, the objective lens too close to the sample and the tip interferes with a sample holder holding the sample.

Accordingly, an object of the present invention is to provide a scanning probe microscope in which an objective lens used to radiate exciting light can be disposed more near a sample and a tip.

### Solution to Problem

To achieve the foregoing object, according to the present invention, a scanning probe microscope includes: a sample holder configured to hold a sample; a tip disposed near the sample; an exciting light source configured to output exciting light; an objective lens configured to condense the exciting light and radiating the exciting light to the tip; a light reception unit configured to detect scattering light generated from the sample through the radiation of the exciting light; and an incident position adjustment unit configured to cause the exciting light to be incident on a position deviating from an optical axis of the objective lens.

### Advantageous Effects of Invention

According to the present invention, it is possible to provide a scanning probe microscope in which an objective lens used to radiate exciting light can be disposed more near a sample and a tip.

### BRIEF DESCRIPTION OF DRAWINGS

FIG. 1 is a diagram illustrating a schematic configuration of a first example of a scanning probe microscope.

FIG. 2A is a perspective view illustrating an example of a cantilever.

FIG. 2B is a sectional view taken along the line A-A of FIG. 2A.

FIG. 3 is a diagram illustrating an example of a position at which exciting light is incident on an objective lens.

FIG. 4 is a diagram illustrating a schematic configuration of a second example of the scanning probe microscope.

FIG. 5 is a diagram illustrating a schematic configuration of a third example of the scanning probe microscope.

FIG. 6 is a diagram illustrating a configuration of an integrated optical system.

FIG. 7A is a diagram illustrating a tilting mechanism tilting the integrated optical system.

FIG. 7B is a diagram illustrating a state in which the integrated optical system is tilted.

FIG. 8 is a diagram illustrating a simulation result of a relationship between electric field intensity near a vertex portion of a tip and a radiation angle of the exciting light.

FIG. 9A is a diagram illustrating adjustment of a relative angle between the cantilever and the exciting light.

FIG. 9B is a diagram illustrating adjustment of a relative angle between the cantilever and the exciting light.

FIG. 9C is a diagram illustrating adjustment of a relative angle between the cantilever and the exciting light.

FIG. 10A is a diagram illustrating optimization of the radiation angle of the exciting light.

FIG. 10B is a diagram illustrating optimization of the radiation angle of the exciting light.

FIG. 10C is a diagram illustrating optimization of the radiation angle of the exciting light.

FIG. 11 is a diagram illustrating comparison between Raman spectroscopy and tip-enhanced Raman spectroscopy of a sample formed on a metal substrate.

FIG. 12 is a diagram illustrating disposition of the cantilever and the objective lens in liquid.

FIG. 13A is a diagram illustrating a modification of the objective lens.

FIG. 13B is a diagram illustrating a modification of the objective lens.

FIG. 13C is a diagram illustrating a modification of the objective lens.

### DESCRIPTION OF EMBODIMENTS

In the following embodiments, a section or embodiment are divided into a plurality of sections or embodiments in description as necessary for convenience, but the sections and the embodiments are not unrelated to each other unless stated particularly, and one side is in relationship of modifications, details, supplementary description, or the like with a part or all of the other side.

In the following embodiments, when the number of elements or the like (including a number, a numerical value, an amount, a range, and the like) is mentioned, the number of elements is not limited to a specific number, and a specific number or more or less can be used unless stated clearly and limited to a specific number clearly in principle.

Further, in the following embodiments, it is needless to say that the constituents (including element steps or the like) are not necessarily required constituents unless stated clearly and essential clearly in principle.

Similarly, in the following embodiments, when shapes, positional relationships, and the like of constituents are mentioned, substantially approximate or similar shapes and the like are included unless stated clearly and considered otherwise apparently in principle. The same applies to the above numerical values and ranges.

In all the drawings for describing embodiments, the same members are denoted by the same reference numerals in principle and repeated description thereof will be omitted. Even in plan views, hatching is added in some cases so that the drawings can be easily understood.

### Overview of Scanning Probe Microscope

A scanning probe microscope (SPM) is a generic name of a microscope typified by a scanning tunneling microscope or an atomic force microscope. The scanning probe microscope is a microscope that scans a sample with a minute tip (probe) and observes a shape or a property of the sample. In particular, in the scanning probe microscope, an expanded image or physical property information of a sample surface can be obtained by approaching a vertex portion of the tip to the surface of the sample and performing scanning while detecting a dynamic and electromagnetic interaction between the sample and the tip. For example, the scanning probe microscope has a resolution at an atomic level or a molecular level for a sample. In recent years, physical property information such as an optical property of a sample is inspected using the scanning probe microscope. Specifically, exciting light is radiated from a light source to the tip, near-field light is formed in the vertex portion of the tip in which a local electric field is focused, and scattering light generated from the sample by the near-field light is detected. By analyzing the detected scattering light, physical property information of the sample is obtained. For example, when Rayleigh scattering light is detected as scattering light, physical property information such as reflectance, absorptance, and surface roughness of the surface of the sample can be obtained. When Raman scattering light is detected, a type of chemical bond or a substance of the sample can be identified.

The scanning probe microscope according to the embodiment can be applied widely to technologies for detecting Rayleigh scattering light or Raman scattering light and, in particular, is useful to detect Raman scattering light for spectrometry. That is, the scanning probe microscope according to the embodiment is a microscope that perform tip-enhanced Raman spectroscopy using near-field light formed in the vertex portion of the tip and it is devised that an objective lens used to radiate exciting light to the tip is disposed more near the sample and the tip. Hereinafter, a configuration of the scanning probe microscope including the tip will be described.

### Configuration Example 1 of Scanning Probe Microscope

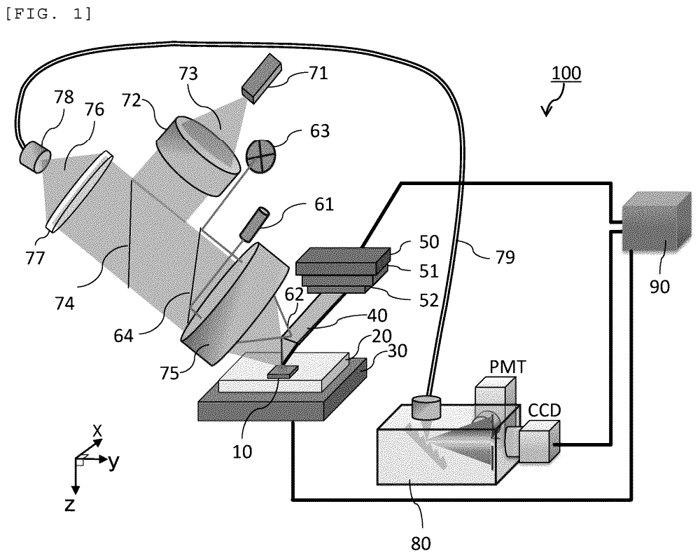

A configuration of a first example of the scanning probe microscope will be described with reference to FIG. 1. FIG. 1 is a perspective view and it is assumed that a vertical direction is a Z direction and a horizontal direction is X and Y directions. A scanning probe microscope 100 exemplified in FIG. 1 is also referred to as, for example, a scanning near-field optical microscope (SNOM) or a tip-enhanced Raman scattering (TERS) microscope. The scanning probe microscope 100 includes a sample holder 20, a cantilever 40, an exciting light source 71, an objective lens 75, a collimator 78, and a control unit 90. Hereinafter, each unit will be described.

A sample 10 which is a measurement target is mounted on the sample holder 20 and the sample holder 20 is disposed above a movable stage 30. The movable stage 30 is a stage that can be moved in two XY directions or three XYZ directions and is configured using, for example, a piezoelectric element. The piezoelectric element may also be referred to as a piezoelectric actuator.

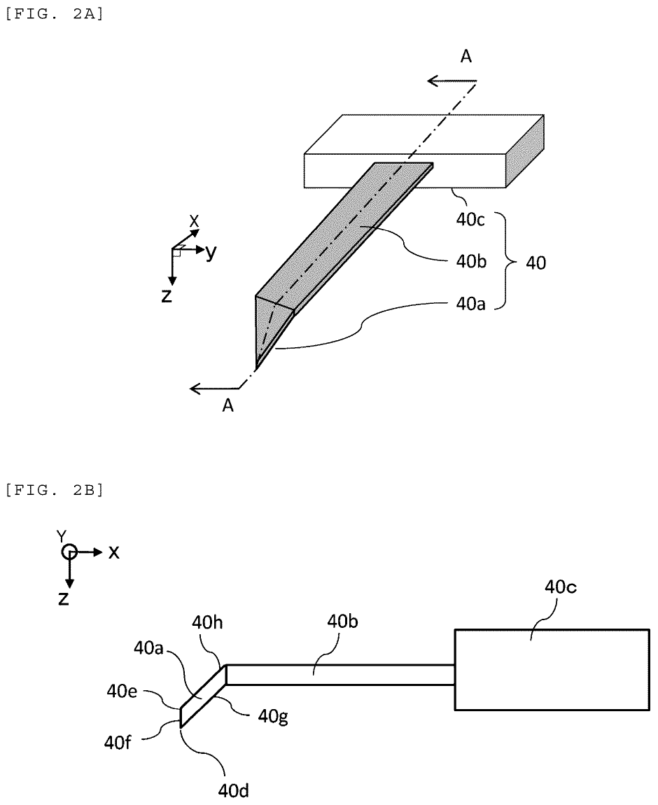

The cantilever 40 is a cantilever beam that has a tip disposed to be close to the sample 10 at one end. A configuration of the cantilever 40 will be described with reference to FIG. 2A. The cantilever 40 includes a tip 40a, a beam portion 40b, and a held portion 40c. The beam portion 40b is a deformable member that extends in the X direction, the tip 40a is provided at one end, and the held portion 40c is provided at the other end. The held portion 40c is connected to a vibration unit 52 to be described below. In FIG. 2, a feature of the cantilever can also be said to have a shape in which a boundary between the beam portion 40b and the tip 40a is bent. Although not illustrated, the beam portion 40b and the tip 40a may not have the same thickness and the thickness of each portion may not be uniform.

The tip 40a will be described with reference to FIG. 2B that is a sectional view taken along the line A-A of FIG. 2A. The tip 40a is a member that is formed of silicon, silicon oxide, silicon nitride, carbon, or the like and has a shape protruding in the Z direction, and includes a vertex portion 40d, a superior angle portion 40e, a ridge line portion 40f, a tilted surface portion 40g (which is referred to as a lower tilted surface portion when it is distinguished), and a tilted surface portion 40h (which is referred to as an upper tilted surface portion when it is distinguished). The vertex portion 40d is a forefront of the tip 40a and is disposed to be close to the sample 10. The superior angle portion 40e is a corner located above the vertex portion 40d (specifically, a forefront of a corner illustrated in FIG. 2A). The ridge line portion 40f is a portion (specifically, ridge line) linking the vertex portion 40d to the superior angle portion 40e. The tilted surface portion 40g is a portion (surface) linking the vertex portion 40d to the lower surface of the beam portion 40b. The tilted surface portion 40h is a portion (surface) linking the superior angle portion 40e to the upper surface of the beam portion 40b. In the tip 40a, at least the vertex portion 40d and the ridge line portion 40f which is the periphery of the vertex portion 40d are covered with a noble metal film. The tip 40a is not limited to the shape exemplified in FIG. 2.

If a technology of manufacturing the tip 40a is ideal and corners of the tip 40a can be precisely formed as illustrated in FIGS. 2A and 2B, each portion is a point, a line, or a surface itself. However, a rim of a forefront, a corner, a line, or a surface actually has roundness within a range satisfying accuracy required in the cantilever 40. Each portion may include a peripheral region including a beginning and a termination of the roundness.

FIG. 1 is referred to back for description. The vibration unit 52 to which the held portion 40c of the cantilever 40 is connected is configured using, for example, a piezoelectric element, vibrates the cantilever 40, and is connected to a Z scanning unit 51. The Z scanning unit 51 is a stage that is movable in the Z direction, is configured using, for example, a piezoelectric element, and is connected to an XY scanning unit 50. The XY scanning unit 50 is a stage that is movable in two XY directions, is configured using, for example, a piezoelectric element, and is connected to the casing of the scanning probe microscope 100. The vibration unit 52 may be configured using another actuator when the vibration unit 52 can vibrate the cantilever 40.

That is, the cantilever 40 is held in the casing of the scanning probe microscope 100 via the vibration unit 52, the Z scanning unit 51, the XY scanning unit 50, can scan the sample 10 by the XY scanning unit 50, and can be vibrated by the vibration unit 52. The sample 10 can also be scanned with the cantilever 40 by the movable stage 30, and thus a configuration in which any one of the movable stage 30 and the XY scanning unit 50 is included may be adopted. When the cantilever 40 has self-detection performance, the vibration unit 52 may not be included.

The exciting light source 71 outputs exciting light 73 radiated to the tip 40a. The exciting light 73 may be laser light with a single wavelength or may be laser light of which a wavelength can be converted. The exciting light 73 output from the exciting light source 71 is condensed by a lens 72, is reflected from a filter 74, and is incident and condensed on the objective lens 75, and then is radiated to the tip 40a of the cantilever 40. Near-filed light formed at the vertex portion 40d of the tip 40a through the radiation of the exciting light 73 causes scattering light to be generated from the sample 10. Of the scattering light generated from the sample 10, light collected in the objective lens 75 passes through the filter 74, is condensed in a lens 77, and then is incident as detected light 76 on the collimator 78. After the detected light 76 incident on the collimator 78 is sent to and dispersed by a spectroscope 80 via an optical fiber 79, intensity is measured by a photodetector such as a photomultiplier tube (PMT), a photodiode (PD), or a HgCdTe (MCT) sensor in some cases. The detected light 76 may be incident on the spectroscope 80 or the photodetector without passing through the collimator 78 or the optical fiber 79. An entity detecting the scattering light generated from the sample may be an entity other than the above-described spectroscope 80 and such entities are collectively referred to as a light reception unit.

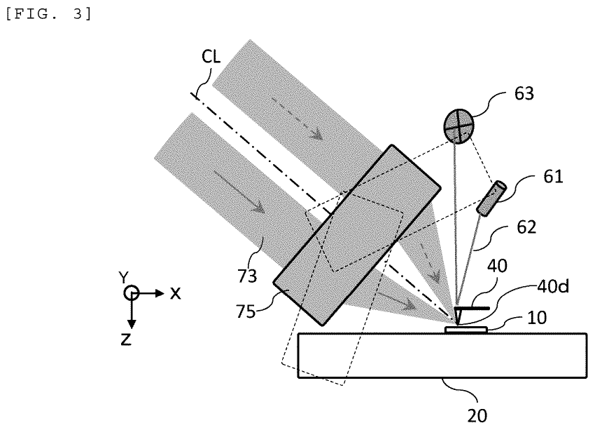

A position at which the exciting light 73 is incident on the objective lens 75 will be described with reference to FIG. 3. In the embodiment, the exciting light 73 is incident on a position deviating from an optical axis CL of the objective lens 75. The exciting light 73 incident on the position deviating from the optical axis CL of the objective lens 75 is condensed by the objective lens 75, and then is radiated to the tip 40a of the cantilever 40 from a direction tilted with respect to the optical axis CL. That is, by causing the exciting light 73 to be incident on the position deviating from the optical axis CL, the objective lens 75 can be disposed more near the sample 10 and the tip 40a without interfering with the sample holder 20 even when the exciting light 73 is radiated to the tip 40a from a direction closer to the horizontal direction. Even when the exciting light 73 is radiated to the tip 40a from a direction closer to the vertical direction, the objective lens 75 can be disposed more near the tip 40a without interfering with an optical path and hard disposition of an optical lever. By disposing the objective lens 75 more near the sample 10 and the tip 40a, more scattering light generated omnidirectionally from the sample 10 can be collected by the objective lens 75, and thus it is possible to improve detection efficiency of the scattering light.

FIG. 1 is referred to back for description. The scanning probe microscope 100 includes an optical lever light source 61 and an optical lever detector 63 in order to detect deformation of the beam portion 40b of the cantilever 40. The optical lever light source 61 outputs optical lever light 62 radiated to the beam portion 40b. The optical lever light 62 output from the optical lever light source 61 is reflected from a dichroic mirror 64, is incident on the objective lens 75, passes through the objective lens 75, and is then radiated to the beam portion 40b. The optical lever light 62 radiated to the beam portion 40b is reflected from the beam portion 40b, passes through the objective lens 75, then is reflected from the dichroic mirror 64, and is detected by the optical lever detector 63. The optical lever detector 63 includes a plurality of detection elements, for example, four detection elements, and detects deformation or vibration of the beam portion 40b based on an output signal of each detection element. By sharing the objective lens 75 used to radiate the exciting light 73 with the optical lever light 62, it is possible to simplify a configuration related to the optical lever light 62 and improve the degree of freedom of the disposition of the other configurations.

The control unit 90 is a computer that controls each unit and graphs intensity of scattering light measured by the photodetector to output the graph or records data. For example, the control unit 90 adjusts a relative distance between the cantilever 40 and the sample 10 to approach the tip 40a of the cantilever 40 to the sample 10 or scan the entire surface of the sample 10 with the tip 40a by controlling an operation of the movable stage 30, the XY scanning unit 50, or the Z scanning unit 51. The control unit 90 calculates a force working between the tip 40a and the sample 10 or a distance between the tip 40a and the sample 10 or controls the movable stage 30 or the Z scanning unit 51 so that a deformation amount of the beam portion 40b is constant based on deformation of the beam portion 40b of the cantilever 40 detected by the optical lever detector 63. The computer has one or more processors and one or more storage resources and implements the foregoing or following process by causing the processor to execute a program stored in the storage resource. An example of the processor is a CPU or a GPU. An example of the storage resource is a RAM in the case of a volatile memory, and is a flash memory, an HDD, or a USB memory in the case of a nonvolatile memory.

An operation of the scanning probe microscope 100 will be described. First, the tip 40a of the cantilever 40 is disposed near the sample 10 through an operation of the movable stage 30 or the XY scanning unit 50. Subsequently, the optical lever light 62 is radiated from the optical lever light source 61 to the beam portion 40b of the cantilever 40, and the optical lever light 62 reflected from the beam portion 40b is detected by the optical lever detector 63. The exciting light 73 is radiated from the exciting light source 71 to the tip 40a and near-field light is formed at the vertex portion 40d of the tip 40a. The scattering light including Raman scattering light is generated from the sample 10 by the near-field light, and light collected by the objective lens 75 in the generated scattering light is incident on the collimator 78 as the detected light 76 via the dichroic mirror 64, the filter 74, and the lens 77 and is detected by the spectroscope 80. Further, the control unit 90 may generate a Raman spectrum image through near-field light radiation or a surface unevenness image by the scanning probe microscope based on a signal dispersed and detected by the spectroscope 80 and cause a display device such as a liquid crystal display to display the Raman spectrum image or the surface unevenness image.

### Configuration Example 2 of Scanning Probe Microscope

A configuration of a second example of the scanning probe microscope will be described with reference to FIG. 4. A scanning probe microscope 200 exemplified in FIG. 4 detects light passing through the sample 10 in scattering light generated from the sample 10. That is, the configurations other than a configuration related to the detection of the scattering light are the same as those of the scanning probe microscope 100 exemplified in FIG. 1. The same configurations as those of the scanning probe microscope 100 are denoted by the same reference numerals, and description thereof will be omitted.

The scanning probe microscope 200 includes the sample holder 20, the cantilever 40, the exciting light source 71, the objective lens 75, the collimator 78, the control unit 90, a movable stage 31, a lens 21, and a lens 22. The movable stage 31 is a stage which is movable in two XY directions or three XYZ directions, is configured using, for example, a piezoelectric element, and includes an opening 32. The lenses 21 and 22 are disposed below the movable stage 31 along with the collimator 78.

An operation of the scanning probe microscope 200 will be described. As in the scanning probe microscope 100, when the exciting light 73 is radiated to the tip 40a disposed near the sample 10, near-field light is formed at the vertex portion 40d of the tip 40a. The scattering light is generated from the sample 10 by the near-field light, and light passing through the sample 10 in the generated scattering light is incident on the collimator as detected light 23 via the sample holder 20, the opening 32, the lens 21, and the lens 22, and is detected by the spectroscope 80.

With the scanning probe microscope 200, since the scattering light generated from the sample 10 is detected without being blocked by the cantilever 40 or the movable stage 31, it is possible to improve detection efficiency of the scattering light. As a result, it is possible to obtain a near-field optical image or a Raman spectrum image with high contrast.

### Configuration Example 3 of Scanning Probe Microscope

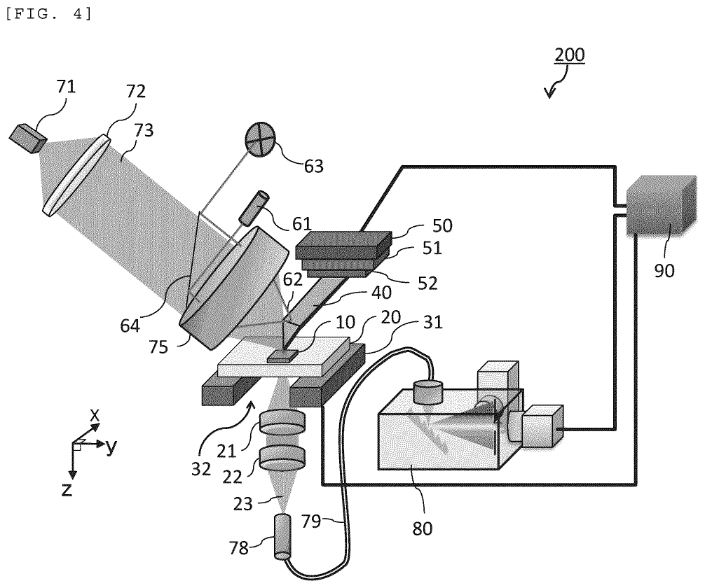

A configuration of a third example of the scanning probe microscope will be described with reference to FIG. 5. A scanning probe microscope 300 exemplified in FIG. 5 detects light radiated in a side surface direction of the cantilever 40 in scattering light generated from the sample 10. That is, the configurations other than a configuration related to the detection of the scattering light are the same as those of the scanning probe microscope 100 exemplified in FIG. 1. The same configurations as those of the scanning probe microscope 100 are denoted by the same reference numerals, and description thereof will be omitted.

The scanning probe microscope 300 includes the sample holder 20, the cantilever 40, the exciting light source 71, the objective lens 75, the collimator 78, the control unit 90, the lens 21, and the lens 22. The lenses 21 and 22 are disposed in the side surface direction of the cantilever 40 along with the collimator 78.

An operation of the scanning probe microscope 300 will be described. As in the scanning probe microscope 100, when the exciting light 73 is radiated to the tip 40a disposed near the sample 10, near-field light is formed at the vertex portion 40d of the tip 40a. The scattering light is generated from the sample 10 by the near-field light, and light radiated in the side surface direction of the cantilever 40 in the generated scattering light is incident on the collimator as the detected light 23 via the lenses 21 and 22, and is detected by the spectroscope 80.

With the scanning probe microscope 300, the scattering light can be collected in multiple directions. Therefore, it is possible to perform measurement on which it is difficult to have an influence of the shape of the sample 10. In particular, when a position of the tip 40a to which the exciting light 73 is radiated is relatively away from a position at which the near-field light is generated such that the scattering light generated from the sample 10 by the near-field light cannot be sufficiently collected by the objective lens 75, the scanning probe microscope 300 is useful. The position of the exciting light source 71 or the objective lens 75 and the position of the collimator 78, the lens 21, or the lens 22 are not limited to the positions exemplified in FIG. 5, but the positions of both may be exchanged with each other.

### Configuration of Integrated Optical System

A configuration of an integrated optical system 400 related to the exciting light 73 and the detected light 76 of the scanning probe microscope 100 will be described with reference to FIG. 6. There is a considerable individual difference in the shape of the tip 40a which is a minute member in manufacturing. The intensity of the near-field light formed at the vertex portion 40d of the tip 40a through the radiation of the exciting light 73 depends on the shape of the tip 40a or a radiation angle and a radiation position of the exciting light 73. Accordingly, the radiation angle or the radiation position of the exciting light 73 can be preferably adjusted in accordance with the shape of the tip 40a. The integrated optical system 400 according to the embodiment has a function of adjusting the radiation angle or the radiation position of the exciting light 73.

The integrated optical system 400 includes various optical filters, optical mirrors, and lenses in addition to the exciting light source 71, the objective lens 75, the collimator 78, the optical lever light source 61, and the optical lever detector 63. Hereinafter, each unit will be described in accordance with travel of the exciting light 73 or the optical lever light 62.

A noise wavelength of the exciting light 73 output from the exciting light source 71 is cut by an optical filter 402, the exciting light is polarized by a polarizer 403, and then is incident on a position and angle adjustment unit 404. The position and angle adjustment unit 404 includes a mirror that reflects the exciting light 73 toward the filter 74, a mechanism that translates the mirror in an incident direction (the X direction in FIG. 6) of the exciting light 73, and a mechanism that tilts the mirror. As these mechanisms, for example, stepping motors or piezoelectric elements may be adopted or other actuators may be used. The exciting light 73 reflected from the mirror of the position and angle adjustment unit 404 passes through lenses 405 and 406, is reflected from the filter 74, passes through the dichroic mirror 64, and is incident on the objective lens 75 to be collected. The exciting light 73 condensed by the objective lens 75 is radiated to the tip 40a of the cantilever 40 so that near-field light is formed at the vertex portion 40d of the tip 40a. A part of the scattering light generated from the sample 10 by the near-field light formed at the vertex portion 40d is collected by the objective lens 75, passes through the dichroic mirror 64, the filter 74, a beam splitter 410, is condensed by the lens 77, and then is incident as the detected light 76 on the collimator 78.

The position and angle adjustment unit 404 is controlled by the control unit 90 to translate or tilt the mirror. When a position at which the exciting light 73 is incident on the objective lens 75 is adjusted through the translation of the mirror and an incident position on the objective lens 75 is changed, a radiation angle of the exciting light 73 to the tip 40a is changed. When an angle at which the exciting light 73 is incident on the objective lens 75 is changed by tilting the mirror and the incident angle on the objective lens 75 is changed, a radiation angle and a radiation position of the exciting light 73 to the tip 40a are changed. That is, an angle or a position at which the exciting light 73 is radiated to the tip 40a is adjusted by the position and angle adjustment unit 404. Since the position and angle adjustment unit is a component that adjusts an incident position at which the exciting light is incident, the position and angle adjustment unit may also be referred to as an incident position adjustment unit. As an optical element that changes a direction of exciting light, an element such as a prism other than the above-described mirror may be used.

The objective lens 75 is connected to a focus adjustment unit 409. The focus adjustment unit 409 is a mechanism that translates the objective lens 75 in an incident direction (the X direction in FIG. 6) of the exciting light 73 and adjusts a focus of the light condensed by the objective lens 75.

The optical lever light 62 output from the optical lever light source 61 passes through a beam splitter 415, is reflected from the dichroic mirror 64, and then is incident on the objective lens 75. After the optical lever light 62 incident on the objective lens 75 is reflected from the beam portion 40b of the cantilever 40 and is incident on the objective lens 75 again, the optical lever light 62 is reflected from each of the dichroic mirror 64 and the beam splitter 415 and is detected by the optical lever detector 63.

The integrated optical system 400 may include an observation light source 411 and an observation camera 414 used to observe the cantilever 40 and the sample 10. The observation light source 411 outputs observation light 412. The observation light 412 output from the observation light source 411 passes through a beam splitter 413, is then reflected from the beam splitter 410, passes through the filter 74 and the dichroic mirror 64, and is incident on the objective lens 75. The observation light 412 incident on the objective lens 75 is reflected from the sample 10 and the cantilever 40, is incident on the objective lens 75 again, passes through the dichroic mirror 64 and the beam splitter 415, is reflected from the beam splitter 410 and the beam splitter 413, is then incident on the observation camera 414. The observation camera 414 outputs an observation image based on the incident observation light 412. The observation image is used to align positions of the cantilever 40 and the sample 10.

The beam splitter 410 can be extracted and may be extracted after observation ends in order to improve detection efficiency of scattering light generated from the sample 10. Further, after the observation ends, it is preferable to power off the observation light source 411.

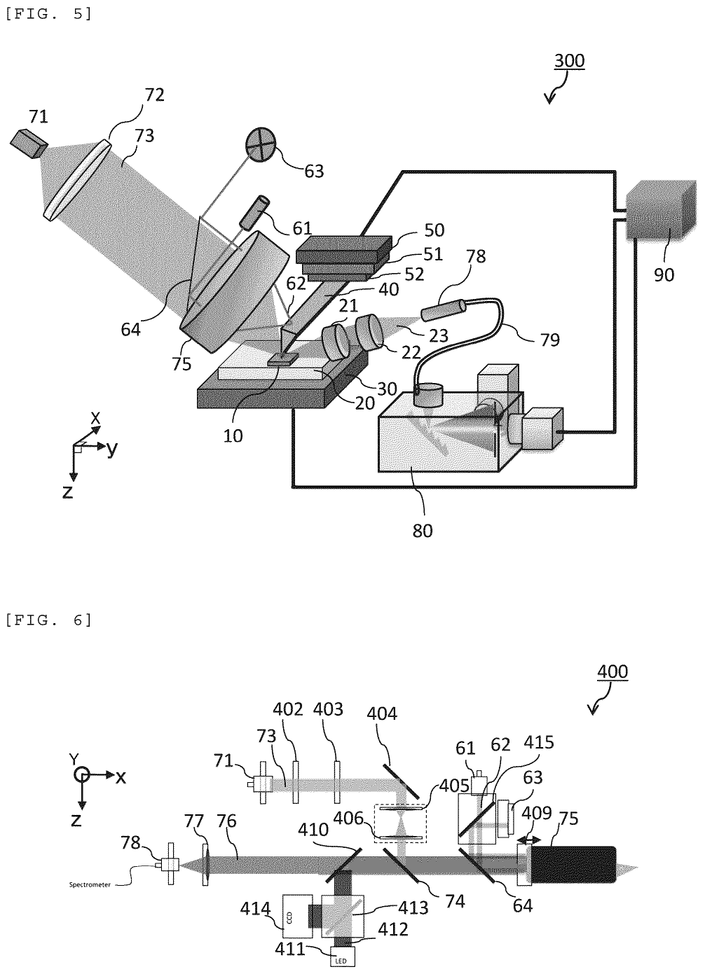

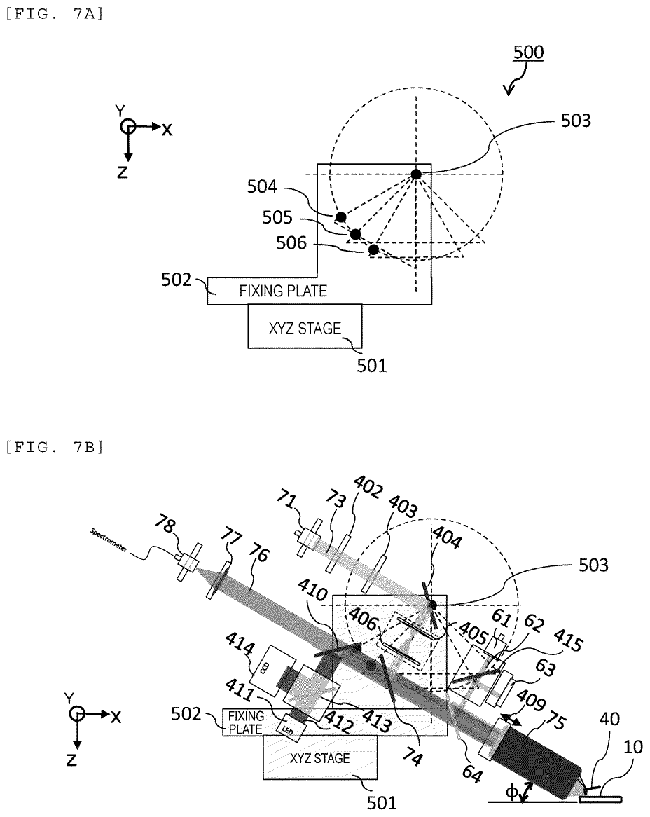

A tilting mechanism 500 which is a mechanism tilting the integrated optical system 400 will be described with reference to FIG. 7A. The tilting mechanism 500 includes an XYZ stage 501 and a fixing plate 502. The XYZ stage 501 is a stage that can be moved in three XYZ directions and is connected to the casing of the scanning probe microscope 100. The fixing plate 502 is a member that includes a rotation shaft 503, a hole 504, a hole 505, and a hole 506 and is connected to the XYZ stage 501. The position and angle adjustment unit 404 of the integrated optical system 400 is rotatably connected to the rotation shaft 503. The holes 504, 505, and 506 are provided at a predetermined interval on a circumference of a circle that has the rotation shaft 503 as a center and has a distance between the position and angle adjustment unit 404 and the filter 74 as a radius. The filter 74 is fixed to any of the holes 504, 505, and 506.

The integrated optical system 400 tilted by the tilting mechanism 500 will be described with reference to FIG. 7B. A state in which the filter 74 is fixed to the hole 506 is exemplified in FIG. 7B. An angle φ formed between the optical axis of the objective lens 75 and the horizontal line is adjusted according to a hole to which the filter 74 is fixed, and is adjusted to φ=60° for the hole 504, φ=45° for the hole 505, and φ=30° for the hole 506. When the mirror of the position and angle adjustment unit 404 is translated with the filter 74 fixed to any of the holes 504, 505, and 506, a radiation angle of the exciting light 73 to the tip 40a of the cantilever 40 is adjusted continuously and accurately.

The tilting mechanism 500 may tilt the integrated optical system 400 not only at a discrete angle but also a continuous angle. The angle may also be changed by an actuator such as a stepping motor or a piezoelectric element.

### Influence of Radiation Angle of Exciting Light

An influence of the radiation angle of the exciting light 73 to the tip 40a will be described with reference to FIG. 8. A graph exemplified in FIG. 8 shows a simulation result of a relationship between a radiation angle θ(°) of the exciting light 73 and electric field intensity (V/m) at a midpoint P between the vertex portion 40d of the tip 40a and the sample 10. The exciting light 73 has a wavelength of 660 nm and is radiated to the superior angle portion 40e of the tip 40a. The radiation angle θ is an angle to Fthe horizontal line. To show an influence of the shape of the tip 40a, two types of simulations in which a length L of the ridge line portion 40f is 1028 nm and 1980 nm were executed.

As shown in the graph of FIG. 8, electric field intensity depends on the radiation angle θ and is maximum at a specific radiation angle. The radiation angle at which the electric field intensity is the maximum differs depending on the length L of the ridge line portion 40f. That is, by adjusting the radiation angle θ of the exciting light 73 in accordance with the tip 40a with a different shape, it is possible to improve electric field intensity of the near-field light.

The wavelength of the exciting light 73 is not limited to 660 nm, but may be a wavelength of a visible light region, a near ultraviolet region, or an infrared region. Here, it is preferable to select a material of a metal film with which the tip 40a is coated in accordance with the wavelength of the exciting light 73. The tip 40a is coated with, for example, a gold film, a silver film, or an aluminum film. The length L of the ridge line portion 40f is preferably shorter than five times the wavelength of the exciting light 73.

### Method of Adjusting Radiation Angle of Exciting Light

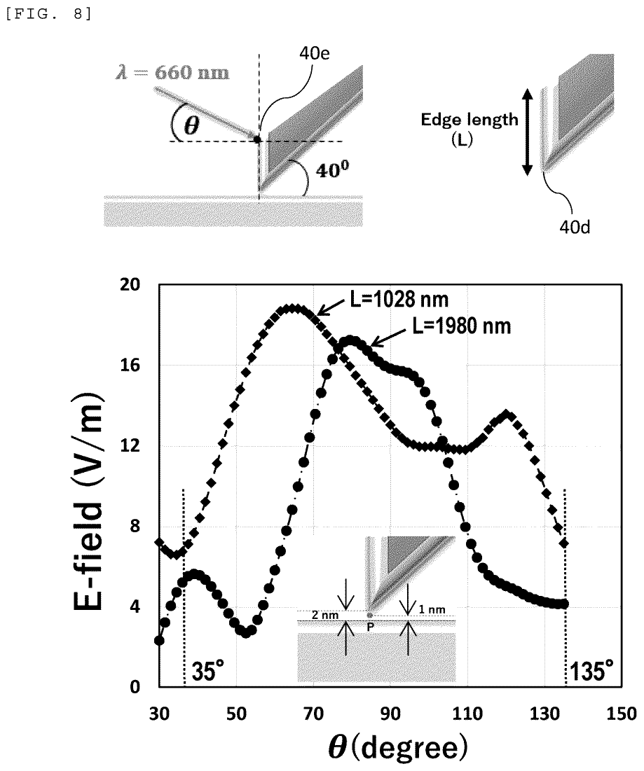

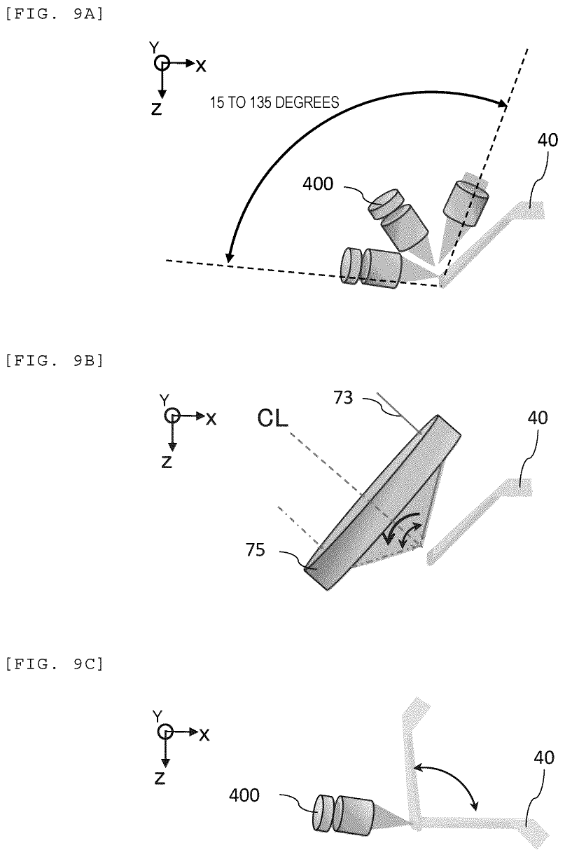

A method of adjusting the radiation angle of the exciting light 73 will be described with reference to FIGS. 9A, 9B, and 9C. FIG. 9A illustrates adjustment of the radiation angle of the exciting light 73 to the cantilever 40 by tilting the integrated optical system 400 within a range of 15° to 135° (here, 0° when parallel to the X axis). When the integrated optical system 400 is tilted, for example, the tilting mechanism 500 is used. The radiation angle of the exciting light 73 is not limited to the range of 15° to 135° when there is no interference with the objective lens 75 and the sample holder 20 or the like. For example, the integrated optical system 400 may be tilted within a range of 0° to 135° parallel to the X axis.

FIG. 9B illustrates adjustment of the radiation angle of the exciting light 73 to the cantilever 40 by changing a position of the exciting light 73 incident on the objective lens 75. When an incident position of the exciting light 73 on the objective lens 75, for example, the position and angle adjustment unit 404 of the integrated optical system 400 is used.

FIG. 9C illustrates adjustment of the radiation angle of the exciting light 73 by tilting the cantilever 40 with respect to the integrated optical system 400. When the cantilever 40 is tilted, for example, the XY scanning unit 50 or the Z scanning unit 51 is used.

According to the methods exemplified in FIGS. 9A, 9B, and 9C, it is possible to adjust the radiation angle of the exciting light 73 to the cantilever 40, and it is possible to improve intensity of the near-field light formed at the vertex portion 40d by adjusting the radiation angle of the exciting light 73.

### Optimization of Radiation Angle of Exciting Light

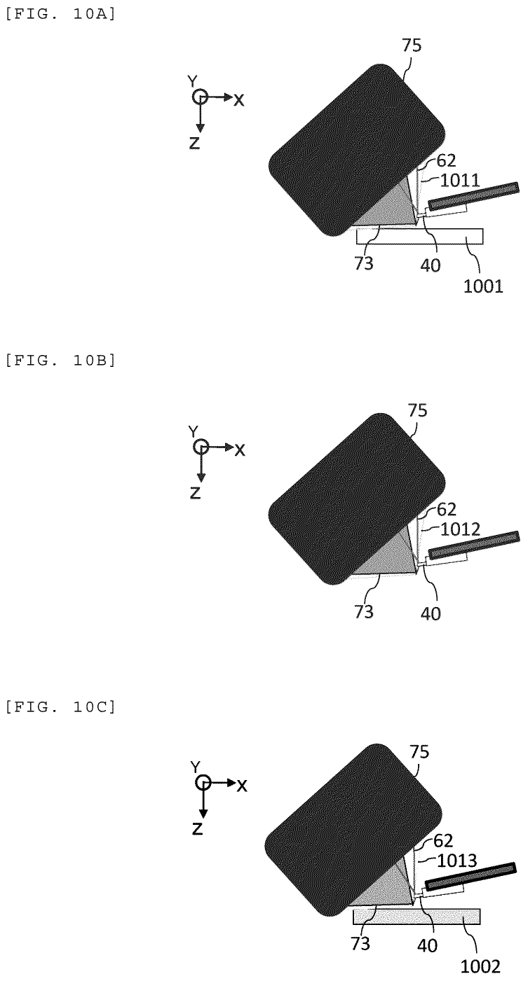

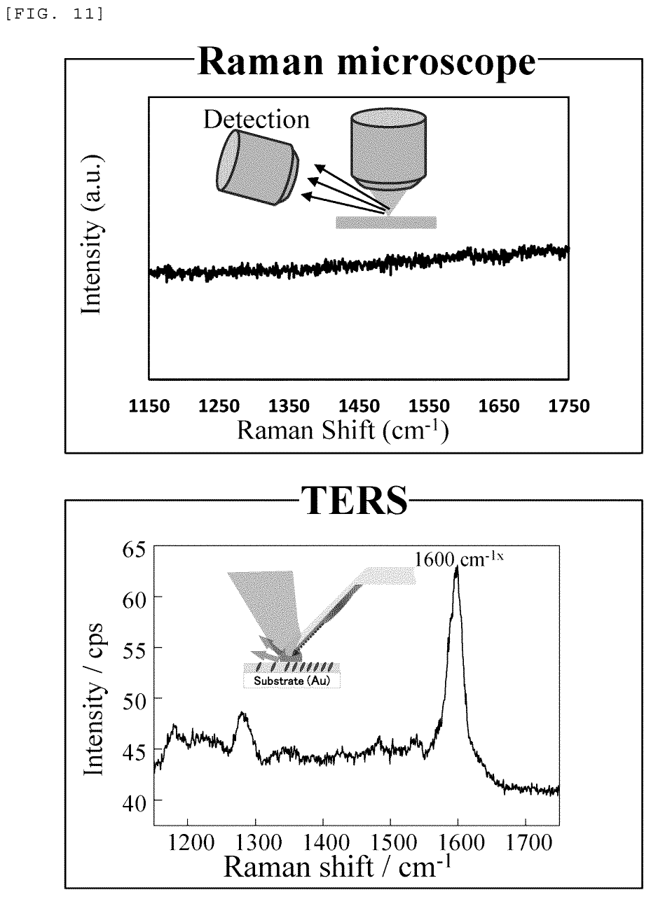

Optimization of the radiation angle of the exciting light 73 will be described with reference to FIGS. 10A, 10B, and 10C. That is, a radiation angle at which the output signal is the maximum is searched for by adjusting the radiation angle of the exciting light 73 while detecting an output signal in accordance with any method to be described below.

FIG. 10A illustrates a method of directly detecting intensity of the near-field light formed near the vertex portion 40d of the tip 40a. That is, while causing to resonate the cantilever 40 disposed near a noble metal substrate sample 1001 of which a substrate is formed of a noble metal by the vibration unit 52, lock-in detection of near-field light scattering light 1011 in which near-field light formed by radiating the exciting light 73 is generated is detected at an excitation frequency. The lock-in detected signal is used to adjust the radiation angle of the exciting light 73.

FIG. 10B illustrates a method of measuring Raman scattering light 1012 of a material attached to the tip 40a. Since carbon in the atmosphere is attached to the tip 40a, a Raman signal of a D band or a G band of the attached carbon is included in the Raman scattering light 1012 to be measured. Accordingly, the Raman signal of the D band or the G band of carbon is extracted from the Raman scattering light 1012 to be measured and the extracted Raman signal is used to adjust the radiation angle of the exciting light 73. The D band is a Raman signal in a defect structure and the G band is a Raman signal in a graphite structure.

FIG. 10C illustrates a method of measuring a reference sample 1002. That is, the exciting light 73 is radiated to the tip 40a of the cantilever 40 disposed near the reference sample 1002, and specific Raman scattering light 1013 which is generated by the near-field light formed at the vertex portion 40d of the tip 40a is detected. A detected scattering light signal is used to adjust the radiation angle of the exciting light 73.

As the reference sample 1002, a silicon single crystal substrate, diamond, or the like is used. As a reference sample for tip-enhanced Raman spectroscopy, a sample in which an organic material is formed on a noble metal substrate, for example, a sample in which a monomolecular film is formed on a metal substrate, may be used. A sample in which a 2D material thin film such as graphene or MoS₂ is formed on a noble metal substrate may be used as the reference sample.

As illustrated in FIG. 11, for a sample in which 4-PBT is formed on a metal substrate, a Raman spectrum is not detected in a general Raman spectroscopy system, but a Raman spectrum is detected in tip-enhanced Raman spectroscopy. Accordingly, by using 4-PBT film on a metal substrate as the reference sample, it is possible to more accurately evaluate intensity of the near-field light formed near the vertex portion 40d of the tip 40a. The reference sample may be used not only to optimize the radiation angle of the exciting light 73 but also to confirm performance of a tip-enhanced Raman spectroscopy device or adjust another optical system. When Rayleigh scattering light or fluorescent light is generated from the reference sample apart from the Raman scattering light, a scattering light signal extracted from the Rayleigh scattering light or fluorescent light may be used to adjust the radiation angle of the exciting light 73.

### Configuration of Measurement in Liquid

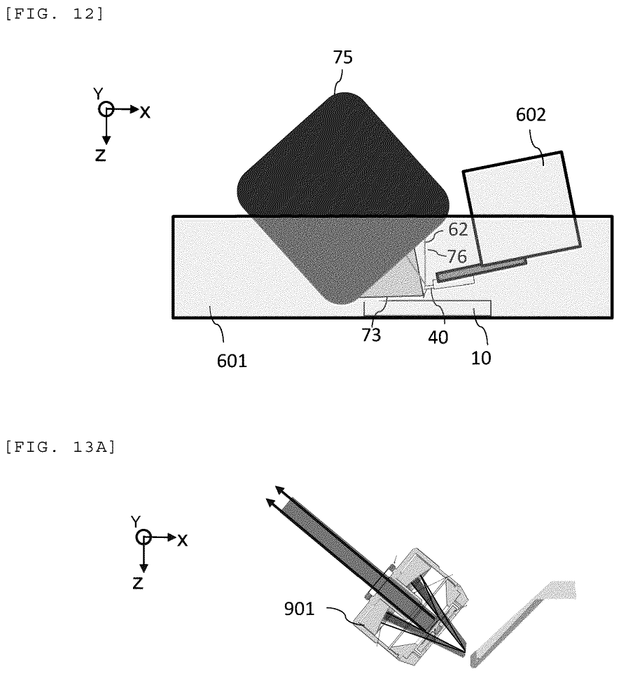

The disposition of the cantilever 40 and the objective lens 75 when the sample 10 in a liquid is measured will be described with reference to FIG. 12. In a configuration exemplified in FIG. 12, a container 601 is included along with the objective lens 75 and the cantilever 40. In the case of the configuration, the cantilever 40 and the sample 10 are disposed in a liquid contained in the container 601. The forefront of the objective lens 75 is also put in the liquid. The exciting light 73 or the optical lever light 62 is radiated from the objective lens 75 to the cantilever 40. The detected light 76 in the scattering light generated from the sample or the optical lever light 62 reflected from the cantilever 40 is collected by the objective lens 75. The other configurations and operations are similar to those of the scanning probe microscope 100, and thus description thereof will be omitted.

In the configuration, a waterproof case 602 may be introduced. For example, the XY scanning unit 50, the Z scanning unit 51, or the vibration unit 52 is installed at a position closer to the tip 40a, but may be surrounded by the waterproof case 602 in order to protect the component of which a function cannot be implemented when the component comes into contact with the liquid. The waterproof case 602 is effective in particular when a water level of the liquid is high.

### Modifications of Objective Lens

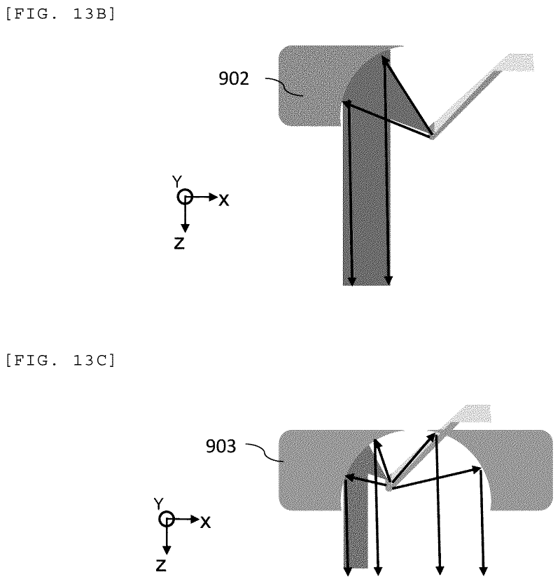

Modifications of the objective lens 75 will be described with reference to FIGS. 13A, 13B, and 13C. The objective lens 75 of the scanning probe microscope 100 exemplified in FIG. 1 is a transmissive objective lens. On the other hand, a reflective objective lens 901 is illustrated in FIG. 13A, a parabolic mirror 902 is illustrated in FIG. 13B, and an integral mirror 903 is illustrated in FIG. 13C. That is, instead of the objective lens 75 which is a transmissive objective lens, any of the reflective objective lens 901, the parabolic mirror 902, and the integral mirror 903 may be used.

The embodiments of the present invention have been described above. The present invention is not limited to the embodiments and constituents may be modified or appropriately combined within a range not departing from the gist of the present invention.

### REFERENCE SIGNS LIST

10: sample
20: sample holder
21: lens
22: lens
23: detected light
30: movable stage
31: movable stage
32: opening
40: cantilever
40a: tip
40b: beam portion
40c: held portion
40d: vertex portion
40e: superior angle portion
40f: ridge line portion
40g: tilted surface portion
40h: tilted surface portion
50: XY scanning unit
51: Z scanning unit
52: vibration unit
61: optical lever light source
62: optical lever light
63: optical lever detector
64: dichroic mirror
71: exciting light source
72: lens
73: exciting light
74: filter
75: objective lens
76: detected light
77: lens
78: collimator
79: optical fiber
80: spectroscope
90: control unit
100: scanning probe microscope
200: scanning probe microscope
300: scanning probe microscope
400: integrated optical system
402: optical filter
403: polarizer
404: position and angle adjustment unit
405: lens
406: lens
409: focus adjustment unit
410: beam splitter
411: observation light source
412: observation light
413: beam splitter
414: observation camera
415: beam splitter
500: tilting mechanism
501: XYZ stage
502: fixing plate
503: rotation shaft
504: hole
505: hole
506: hole
601: container
602: waterproof case
901: reflective objective lens
902: parabolic mirror
903: integral mirror
1001: noble metal substrate sample
1002: reference sample
1011: near-field light scattering light
1012: Raman scattering light
1013: specific Raman scattering light
CL: optical axis of objective lens

1. A scanning probe microscope comprising:
a sample holder configured to hold a sample;
a tip disposed near the sample;
an exciting light source configured to output exciting light;
an objective lens configured to condense the exciting light and radiating the exciting light to the tip;
a light reception unit configured to detect scattering light generated from the sample through the radiation of the exciting light; and
an incident position adjustment unit configured to cause the exciting light to be incident on a position deviating from an optical axis of the objective lens.

2. The scanning probe microscope according to claim 1,
wherein the incident position adjustment unit includes: a mirror that reflects the exciting light; a mechanism that translates the mirror in an incident direction of the exciting light; and a mechanism that tilts the mirror, adjusts a radiation position of the exciting light by tilting the mirror, and adjusts a radiation angle of the exciting light by translating the mirror.

3. The scanning probe microscope according to claim 2, further comprising:
a control unit configured to control the incident position adjustment unit,
wherein the control unit controls a position or an angle of the mirror based on the scattering light detected by the light reception unit.

4. The scanning probe microscope according to claim 3, wherein the control unit controls the position or the angle of the mirror based on a scattering light signal extracted from the scattering light detected by the light reception unit.

5. The scanning probe microscope according to claim 4, wherein the scattering light signal is a signal extracted from at least one piece of scattering light of a Raman scattering light generated from carbon attached to a forefront of the tip or Rayleigh scattering light, Raman scattering light, or fluorescent light generated from a reference sample.

6. The scanning probe microscope according to claim 5,
wherein the scattering light signal is a signal extracted from the Raman scattering light generated from the reference sample, and
wherein, only when the exciting light is radiated, the Raman scattering light is generated from the reference sample.

7. The scanning probe microscope according to claim 2, further comprising a tilting mechanism configured to tilt the exciting light source, the incident position adjustment unit, and the objective lens.

8. The scanning probe microscope according to claim 1, wherein the light reception unit detects scattering light collected by the objective lens.

9. The scanning probe microscope according to claim 1, further comprising:
a cantilever including the tip;
an optical lever light source configured to output an optical lever light; and
an optical lever detector,
wherein light detected by the optical lever detector is optical lever light passing through the objective lens, reflected from the cantilever, and passing through the objective lens again.

10. The scanning probe microscope according to claim 9, wherein the objective lens collects the scattering light detected by the light reception unit.

11. The scanning probe microscope according to claim 1, further comprising:
a container configured to contain a liquid;
a cantilever including the tip;
a vibration unit configured to vibrate the cantilever; and
a waterproof case configured to protect the vibration unit against the liquid,
wherein the sample, the cantilever, and a forefront of the objective lens are disposed in the liquid.

12. The scanning probe microscope according to claim 1, wherein the tip includes a vertex portion, a superior angle portion, and a ridge line portion connecting the vertex portion to the superior angle portion.

13. The scanning probe microscope according to claim 12, wherein a length of the ridge line portion is shorter than 5 times a wavelength of the exciting light.

14. The scanning probe microscope according to claim 1, wherein the objective lens includes at least one of a transmissive objective lens, a reflective objective lens, a parabolic mirror, and an integral mirror.

15. The scanning probe microscope according to claim 1, wherein the incident position adjustment unit adjusts a radiation angle of the exciting light based on the scattering light signal extracted from a scattering light detected by the light reception unit.

16. The scanning probe microscope according to claim 15, wherein the radiation angle is adjusted in a range of 15° to 135°.

17. A sample used in a scanning probe microscope, wherein a substrate is formed of a noble metal.

18. The sample according to claim 17, wherein an organic film is formed on the substrate.
